(19) United States
(12) Patent Application Publication
(10) Pub. No.: US 2018/0254944 A1
(43) Pub. Date: Sep. 6, 2018

(54) METHOD OF PROVIDING LOG INFORMATION, SERVER FOR PROVIDING LOG INFORMATION, AND STORAGE MEDIUM

(71) Applicants: KABUSHIKI KAISHA TOSHIBA, Tokyo (JP); TOSHIBA TEC KABUSHIKI KAISHA, Tokyo (JP)

(72) Inventors: Tatsuya INAGI, Izu Shizuoka (JP); Masaki NARAHASHI, Shinagawa Tokyo (JP); Hiroyo TANAKA, Koto Tokyo (JP); Sou MIYAZAKI, Kawasaki Kanagawa (JP)

(21) Appl. No.: 15/449,544

(22) Filed: Mar. 3, 2017

(51) Int. Cl. H04L 12/24

(52) U.S. Cl. CPC H04L 41/069; H04L 41/16; H04L 41/0631

(57) ABSTRACT

A method of providing access to stored and compressed log information of one or more image forming apparatuses is disclosed. In response to receiving a request for log information, the stored log information is searched based on the received request. An expansion range of the log information is determined based on the searched log information and predetermined setting information. The log information corresponding to the determined expansion range is expanded. A browsing request to browse a portion of the stored log information is received. The portion of the stored log information is transmitted. An association between the log information browsed based on the browsing request and the determined expansion range is machine learned. A correction to the determined expansion range is determined based on the learned association. The correction is stored as the predetermined setting information.

### FIELD Embodiments described herein relate generally to a method of providing log information, a server for providing log information, and a storage medium.

### BACKGROUND

A management system for managing an image forming apparatus—such as a multifunction peripheral (MFP), a printer, or scanner—includes a management device connected through a network. The management device in such a management system receives and stores log information of the image forming apparatus, for example. The management device provides the stored log information for browsing, in some cases. For example, when a problem such as a failure occurs in the image forming apparatus, a service person who maintains the image forming apparatus browses the log information of the image forming apparatus provided from the management device. The service person inspects a cause of the problem in the image forming apparatus from the browsed log information.

Various types of log information items are received by the management device from the image forming apparatus. For example, types of the log information items include a setting value log indicating a change history of a setting value set in the image forming apparatus, a print job log including information such as the number of sheets printed or sheet sizes printed, and an operation log with respect to use of the image forming apparatus by a user. In addition, when the log information is periodically received, the received log information increases over time. Furthermore, when the management device manages a plurality of image forming apparatuses, the log information received by the management device is increased according to the number of the image forming apparatuses. In order for the management device to reduce storage data capacity, the log information may be compressed. Compressing is a process for reducing a data amount by a predetermined algorithm. In order to browse the compressed log information, the compressed log information must be expanded. Expanding is a process for returning the data which is compressed by the predetermined algorithm to the original data. However, when the data amount of the expanding log information is increased, the time required for expanding the information is prolonged and maintenance efficiency by the service person who browses the log information is deteriorated, in some cases. Accordingly, a range of the log information to be expanded is determined in advance, and the time required for expanding the information can be shortened, in some cases. However, when the expansion range of the log information is narrow, a possibility that the necessary log information to be browsed by the service person is not included in the expanded log information becomes higher. When the necessary log information to be browsed is not included in the expanded log information, the compressed log information must be added to the expansion range and then expanded. Such a process may take time which is inconvenient for the service person.

### DESCRIPTION OF THE DRAWINGS

FIG. 1 is a diagram illustrating an example hardware configuration of a log information providing device according to an embodiment.

FIG. 2 is a diagram illustrating an example software configuration of the log information providing device.

FIG. 3 is a sequence diagram illustrating an example log information storing operation of the log information providing device.

FIG. 4 is a sequence diagram illustrating an example log information expanding operation of the log information providing device.

FIG. 5 is a flow chart illustrating an example sequence of operations of the log information expanding operation of the log information providing device.

FIG. 6 is a flowchart illustrating another example sequence of operations of the log information expanding operation of the log information providing device of the embodiment.

FIG. 7 is a flow chart illustrating an example sequence of operations of a log information browsing operation of the log information providing device.

### DETAILED DESCRIPTION

According to an embodiment, a method of providing access to stored and compressed log information of one or more image forming apparatuses is disclosed. In response to receiving a request for log information, the stored log information is searched based on the received request. An expansion range of the log information is determined based on the searched log information and predetermined setting information. The log information corresponding to the determined expansion range is expanded. A browsing request to browse a portion of the stored log information is received. The portion of the stored log information is transmitted. An association between the log information browsed based on the browsing request and the determined expansion range is machine learned. A correction to the determined expansion range is determined based on the learned association. The correction is stored as the predetermined setting information.

Hereinafter, a log information providing method, a log information providing device, and a storage medium of the embodiment will be described with reference to them.

The same reference numerals are given to the same portions in the drawings.

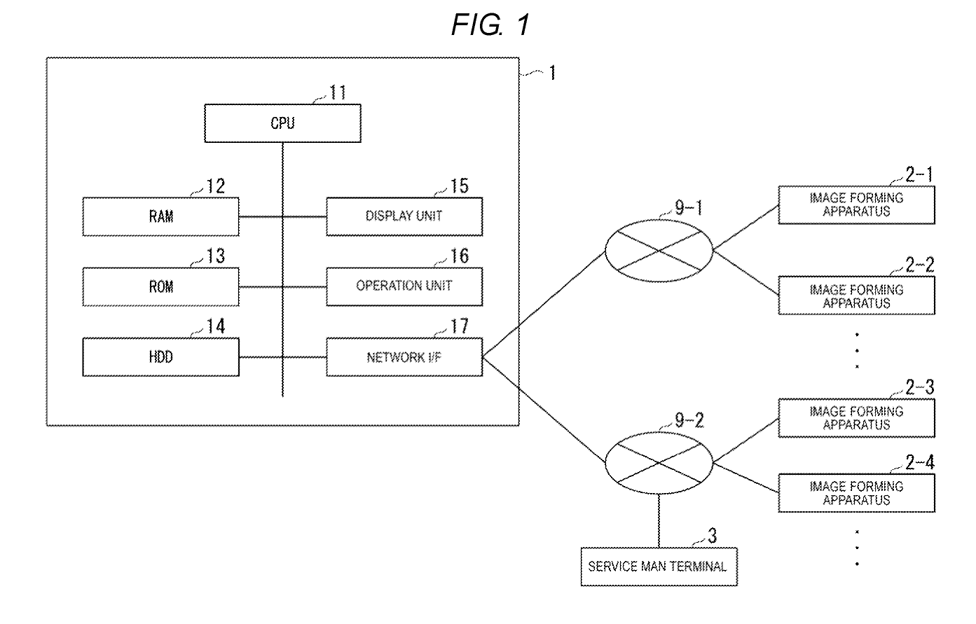

FIG. 1 is a diagram illustrating an example hardware configuration of a log information providing device according to an embodiment. In FIG. 1, a log information providing device 1 includes a central processing unit (CPU) 11, a random access memory (RAM) 12, a read only memory (ROM) 13, a hard disk drive (HDD) 14, a display unit 15, an operation unit 16, and a network interface (I/F) 17. The log information providing device may be implemented as a computer, such as a server or the like.

The CPU 11 executes a program stored in the RAM 12, the ROM 13, or the HDD 14 to control the log information providing device 1. The CPU 11 executes a control program to perform functions of the log information providing device 1. The control program is provided from a storage medium which stores the control program or from a server through a network, for example.

The display unit 15 is, for example, a display device that performs a display function. The operation unit 16 is a keyboard or a mouse that performs an input function, for example. The display unit 15 and the operation unit 16 may be implemented by a device including the display function and the input function such as a touch panel. The network I/F 17 controls a communication between the log information providing apparatus and an image forming apparatus 2. The log information providing apparatus and the image forming apparatus 2 are connected through a network 9 by a wired communication or a wireless communication.

The log information providing device 1 is connected to an image forming apparatus 2-1, an image forming apparatus 2-2, or the like through a network 9-1. In addition, the log information providing device 1 is connected to an image forming apparatus 2-3, an image forming apparatus 2-4, or the like through a network 9-2. The image forming apparatus 2-1 and the like is an example of a case where multiple image forming apparatuses 2 are being used. The log information providing device 1 is connected to the plurality of image forming apparatuses to communicate with each of the image forming apparatuses, respectively. In the following description, a case where the number of each of the log information providing device 1 and the image forming apparatus 2 is one, respectively, will be described. However, the number of each of the log information providing device 1 and the image forming apparatus 2 is not limited thereto.

FIG. 1 illustrates a case where the log information providing device 1 is connected to the image forming apparatus 2 through the network 9-1 and the network 9-2.

The type of each network is, for example, a network using a wired local area network (LAN), a wireless LAN, a near field communication, a moving body communication, or the like. The type of the network in which the log information providing device 1 is connected to the image forming apparatus 2 is not limited to two types of the networks, and may be one type or three or more types.

The log information providing device 1 is connected to a service terminal 3 through the network 9-2. The service terminal 3 is a computer terminal which is operated by a service person who maintains the image forming apparatus 2. The service terminal 3 is, for example, a laptop-type PC, a tablet PC, a smartphone, or the like. The service person browses log information stored in, and provided from, the log information providing device 1, using the service terminal 3.

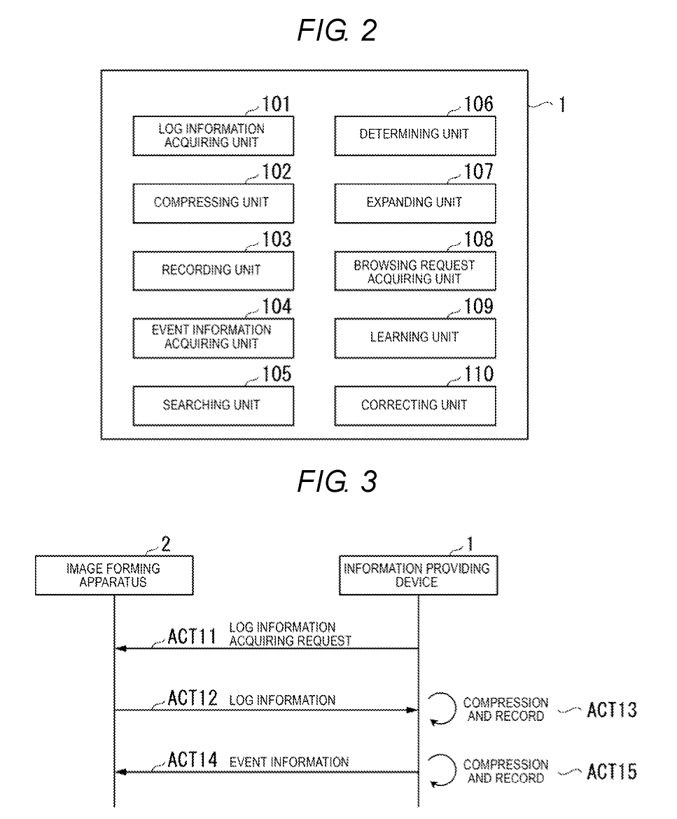

FIG. 2 is a diagram illustrating an example software configuration of the log information providing device 1. The log information providing device 1 is configured to function as a log information receiving unit 101, a compressing unit 102, a storage unit 103, an event information receiving unit 104, a searching unit 105, a determining unit 106, an expanding unit 107, a browsing request receiving unit 108, a learning unit 109, and a correcting unit 110. The CPU 11 implements each functional unit illustrated in FIG. 2 on the RAM 12, and the program steps executed by each of the functional units are further described below.

The log information receiving unit 101 receives the log information from the image forming apparatus 2. For example, the log information receiving unit 101 transmits a log information receiving request to the image forming apparatus 2, and receives the log information which is transmitted from the image forming apparatus 2 in accordance with the log information receiving request (pull-type acquisition). The log information receiving unit 101 may transmit the log information receiving request at a fixed time every day, and may transmit the log information receiving request at other times. In addition, the log information receiving unit 101 may receive the log information which is transmitted from the image forming apparatus 2 without transmitting the log information receiving request (push-type acquisition).

The log information is generated in the image forming apparatus 2. Examples of the log information are described below:
Setting value log: the setting value log indicates a change history of a setting value set in the image forming apparatus. Setting value log information may be generated when there is a change in the setting value.
Job log: the job log is associated with the execution of the job. The job log may include, for example, a print job log including information such as the number of prints or a sheet size, a FAX job log including a FAX transmitting and receiving history, a scan job log including a transmitting history of a scan document, or the like. The job log is generated in association with the execution of the job.
Operation log: the operation log includes an operation history with respect to a display unit such as an operation panel of the image forming apparatus by a user.
Driving log: the driving log includes an operating status of driving parts of the image forming apparatus, a replacement history, or the like. The driving log is browsed when inspecting a failure caused by the driving parts.
Consumable goods log: the consumable goods log identifies a usage state of the consumable goods, a complement and replacement history, or the like.
Consumed power log: the consumed power log identifies a transition of consumed power of the image forming apparatus. The log information is browsed when examining energy usage of the image forming apparatus.
Error log: the error log includes a history of various types of errors generated in the image forming apparatus.

When various types of errors stored in the error log are generated, an error notification (to be described later) may be transmitted to the log information providing apparatus 1.
Maintenance log: the maintenance log includes a content of maintenance which is executed in the image forming apparatus, identification information of the service person who performs the maintenance, and the like.
Image log: the image log is information regarding a stored image, and may be used for confirming a disturbance of the image.

The log information receiving unit 101 receives one or more of these log information items or all of the log information items. Timing for receiving the log information may be different depending on the log information.

The compressing unit 102 compresses the log information which is received in the log information receiving unit 101. The algorithm or a compression rate of the compressing process is arbitrarily set. In the present embodiment, since the compressed log information is expanded for browsing, a process of reversible compressing is performed.

The storage unit 103 stores the log information which is compressed in the compressing unit 102. The storage unit 103 stores, for example, the log information to the HDD 14.

The event information receiving unit 104 receives event information. The event information is information of the event generated at various times, for example, an error notification transmitted from the image forming apparatus, a request for receiving the log information which is transmitted from the service terminal 3, or the like.

The searching unit 105 searches the log information which is stored in the storage unit 103 based on the event information which is received by the event information receiving unit 104. The searching of the log information is performed based on a searching keyword, for example. The searching keyword may be, for example, identification information of the image forming apparatus 2, identification information of the service person, or information such as an error code included in the error notification. One or more searching keywords may be used to search the log information. In the present embodiment, the log information is browsed for the purpose of maintenance of the image forming apparatus 2. Accordingly, the searching keyword is preferably a keyword which is useful for the maintenance. For example, when the identification information of the image forming apparatus 2 is used as the searching keyword, the log information of the image forming apparatus 2 which is specified in the identification information can be received.

In addition, when the identification information of the service person is used as the searching keyword, the log information for a matter which is maintained in the past by the corresponding service person or another service person can be received. In addition, when the error code is used as the searching keyword, the log information of the image forming apparatus 2 in which the same error is generated can be received. By adding the searching keyword as additional information to each of the log information items, a searching speed can be improved. However, when a lot of the searching keywords are added, the data amount of the log information is increased. Therefore, the searching keyword which is searched in the past may be learned and may be added to the log information.

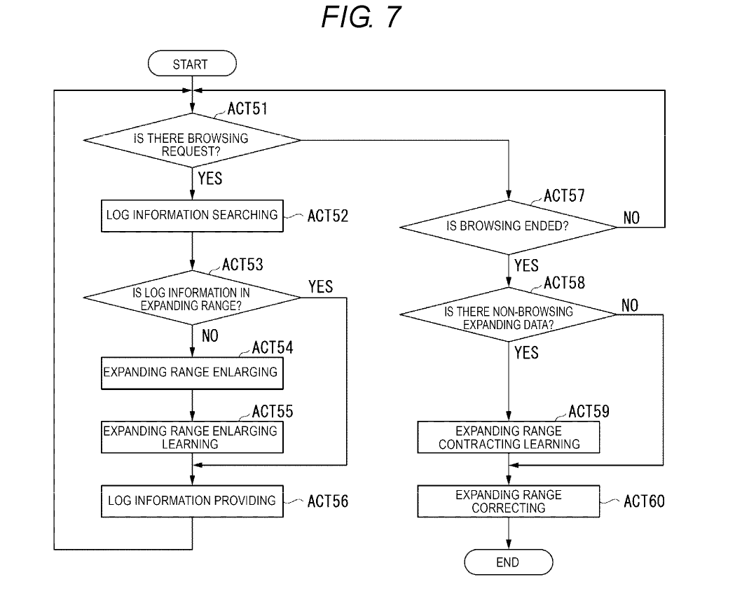

The determining unit 106 determines an expansion range of the compressed log information to be expanded based on the searched log information and a predetermined range, which is generated in advance (predetermined setting information). The predetermined range is generated (including “correction”) by machine learning based on a browsing history of the log information, for example. A machine learning of the predetermined range will be described with reference to FIG. 7 or the like.

The expanding unit 107 expands the log information corresponding to the expansion range of the compressed log information which is determined by the determining unit 106. When previously expanded log information is included in the determined expansion range, the expanding unit 107 expands the log information within the range that was not previously expanded. The expanding unit 107 stores the expanded log information to the RAM 12 or the like.

The browsing request receiving unit 108 receives the browsing request of the stored log information from the service terminal 3.

The browsing request receiving unit 108 may provide a user interface (UI) for a browsing request with respect to the service terminal 3, for example. The browsing request receiving unit 108 in the present embodiment will be described as having a different function from the event information receiving unit 104 for receiving the log information receiving request to be transmitted from the service terminal 3. However, the browsing request receiving unit 108 may receive the log information receiving request instead of the event information receiving unit 104.

The learning unit 109 learns an association between the log information which is browsed based on the browsing request received in the browsing request receiving unit 108 and the expansion range of the log information determined in the determining unit 106. In the present embodiment, learning of an enlarging and contracting of the predetermined range will be described.

### Learning of Enlarging Expansion Range

When the browsed log information is not in the expansion range, the learning unit 109 determines that the expansion range is narrow and learns enlarging of the predetermined range. When the browsed log information is not in the expansion range, there is a possibility that the expansion range is narrow compared to the range of the log information which is required by the service person. The enlarging of the expansion range may be determined based on the plurality of learning results. The enlargement of the expansion range is exemplified below.

### (1) Enlarging Log Store Date

For example, when the store date of the log information of the expansion range is 7 days in the past, and the average date of the recode dates which are actually browsed is 7.5 days, the learning unit 109 enlarges the expansion range in a searching condition which is similar to the searching of the current log information to 8 days in the past.

### (2) Enlarging Types of Logs

For example, when the type of the log information of the expansion range is a job log and an operation log, and the number of times of the browsing of the driving log in the log information which is actually browsed is plural times, the expansion range in the searching condition which is similar to the searching of the current log information is enlarged to the driving log.

The expansion range may be additionally enlarged in the range such as the type of the image forming apparatus that is a target, and the identification information of the service person.

### Learning of Contracting Expansion Range

In the log information which is expanded in the expansion range, when there is log information which is actually not browsed, the learning unit 109 learns to contract the expansion range. When there is log information which is not browsed in the expanded log information, the expansion range has a possibility that the expansion range is broader than the range of the log information which is required to the service person. Also in the contraction of the expansion range, the determination may be performed based on a plurality of learning results. In the contraction of the expansion range, the target of the expansion range same as the enlarging of the expansion range can be contracted.

The correcting unit 110 corrects the expansion range which is determined in the determining unit 106 based on the association which is learned in the learning unit 109. The expansion range is stored as predetermined setting information and referred from the determining unit 106, for example. The correcting unit 110 may overwrite the setting information which is stored by correcting the content of the setting information.

In the present embodiment, a case where the log information providing device 1 executes the above functions of the log information providing device 1 by software is described. However, at least one of the above functions may be executed by hardware. In addition, two or more functions of the above functions may be executed as one functional step. In addition, one function among the above functions may be divided into a plurality of functional steps for execution.

FIG. 3 is a sequence diagram illustrating an example of a log information storing operation of the log information providing device 1.

In FIG. 3, the log information providing device 1 transmits the log information receiving request to the image forming apparatus 2 (ACT 11). The log information providing device 1 may transmit the log information receiving request periodically or at various times to the image forming apparatus 2.

The image forming apparatus 2 which receives the log information receiving request transmits the log information according to the respect (ACT 12). In the log information receiving request, for example, information for specifying the log information may be included.

The log information providing device 1 which receives the log information compresses and stores the received log information (ACT 13). The storage of the log information may be performed with respect to other servers which are not illustrated, for example.

On the other hand, the log information providing device 1 may receive the event information to be transmitted at an arbitrary timing from the image forming apparatus 2 (ACT 14). In the event information, an error notification regarding the failure or the like generated in the image forming apparatus 2 is included. The log information providing device 1 which receives the event information compresses and stores the received event information (ACT 15).

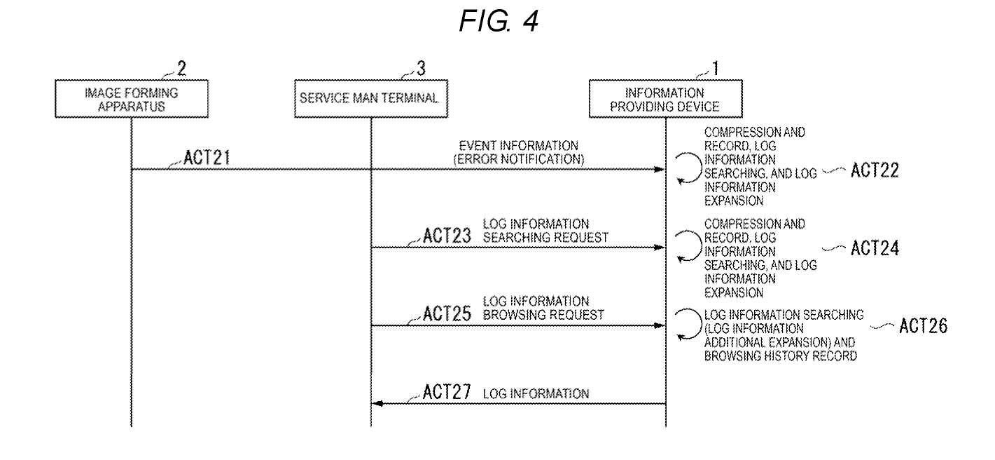

FIG. 4 is a sequence diagram illustrating an example of operations of a log information expanding operation of the log information providing device 1.

In FIG. 4, operations in ACT 21 and ACT 22 illustrate the expanding operation of the log information triggered by the error notification.

The image forming apparatus 2 transmits the error notification to the log information providing device 1 (ACT 21). The transmitting of the error notification in ACT 21 is the same as the operation in ACT 14 of FIG. 3.

The log information providing device 1 which receives the error notification compresses and stores the information of the error notification as illustrated in ACT 15 of FIG. 3. In addition, the log information providing device 1 searches the log information based on the received error notification and expands the searched log information (ACT 22).

In FIG. 4, the operations of ACT 23 and ACT 24 indicate the expanding operation of the log information which is triggered by the log information searching request to be received from the service terminal 3.

The service terminal 3 transmits the log information searching request to the log information providing device 1 (ACT 23). The log information searching request is a searching request for browsing the log information to be transmitted at an arbitrary timing from the service terminal 3. The log information providing device 1 which receives the log information searching request is operated in the same manner of ACT 22. That is, the log information providing device 1 compresses and stores the information of the log information searching request, searches the log information based on the log information searching request, and expands the searched log information (ACT 24).

In FIG. 4, the operations of ACT 25 to ACT 27 indicate the operation when browsing the log information from the service terminal 3.

The service terminal 3 transmits the log information browsing request to the log information providing device 1 (ACT 25). The log information browsing request is a request for browsing the log information and is transmitted at an arbitrary timing from the service terminal 3. In the present embodiment, a case where the service terminal 3 can perform the log information browsing request even when the log information of the browsing target is not expanded is exemplified. That is, the operation of ACT 25 can be performed even when the operation of ACT 22 or ACT 24 is not performed.

The log information providing device 1 which receives the log information browsing request searches the log information, expands the log information when the non-expanded log information is included in the expansion range, and stores the browsing history (ACT 26). The storing of the browsing history is an operation for storing the history of the browsed log information.

The log information providing device 1 provides the requested log information to the service terminal 3 (ACT 27).

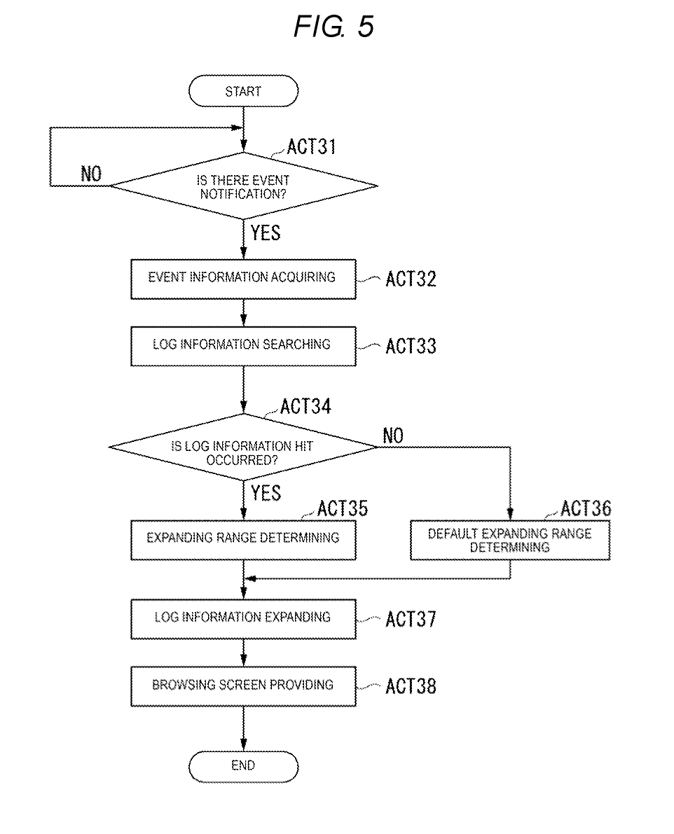

FIG. 5 is a flow chart illustrating an example of the log information expanding operation of the log information providing device 1.

In FIG. 5, the log information providing device 1 determines whether the event notification is received (ACT 31). The receiving of event information in FIG. 5 is triggered with the acquisition of the event notification. When it is determined that the event notification is not received (ACT 31: NO), the log information providing device 1 stands by the acquisition of the event notification by repeating the process of ACT 31.

On the other hand, when it is determined that the event notification is received (ACT 31: YES), the log information providing device 1 receives the event information (ACT 32). In the event information, the error content in the image forming apparatus 2 is included, for example.

After executing the process of ACT 32, the log information providing device 1 searches the stored log information based on the received event information (ACT 33).

After executing the process of ACT 33, the log information providing device 1 determines whether a log information hit occurs in the searching of the log information (ACT 34). The determination of whether the log information hit occurs can be determined based on whether the log information corresponding to the searching condition is included in the stored log information items.

When the log information hit occurs in the searching of the log information (ACT 34: YES), the log information providing device 1 determines the expansion range including the hit log information (ACT 35). The expansion range is determined based on the information for determining the expansion range calculated based on the learning result of the machine learning.

On the other hand, when it is determined that the log information hit does not occur in the searching of the log information (ACT 34: NO), the log information providing device 1 determines a default expansion range (ACT 36). The default expansion range is a predetermined expansion range in which the learning result of the machine learning is not reflected, for example.

After executing the process of ACT 35 or the process of ACT 36, the log information providing device 1 expands the stored log information (ACT 37), based on the expansion range which is determined in the process of ACT 35 or the process of ACT 36.

After executing the process of ACT 37, the log information providing device 1 provides a browsing screen with respect to the service terminal 3. The browsing screen is a Web screen which is capable of displaying on a Web browser of the service terminal 3, for example. The log information providing device 1 may display the log information which is capable of browsing and selection on the browsing screen. The log information providing device 1 may display additional information of expanded or non-expanded information with respect to the log information to be displayed on the browsing screen.

By the above processes, the log information predicted to be of interest with respect to the image forming apparatus 2 which generates the event notification of the error or the like is generated becomes expanded. The service person can browse the log information with reduced time required to expand the log information. Accordingly, the log information providing device 1 can realize maintenance efficiency of the image forming apparatus 2 by the service person.

In FIG. 5, the error content included in the event information is not described in detail. However, in the error of the image forming apparatus 2, the maintenance for sequentially inspecting the plurality of causes is performed in some cases. It is preferable that the expansion range of the log information in the present embodiment is used in the range which is required for the service person. For example, there is a case where the determination of whether a plurality of causes is an error content to be inspected by the event information received from the image forming apparatus 2 can be made. In this example, the log information providing device 1 may appropriately expand the log information which is required for inspecting the causes by the instruction of the service person.

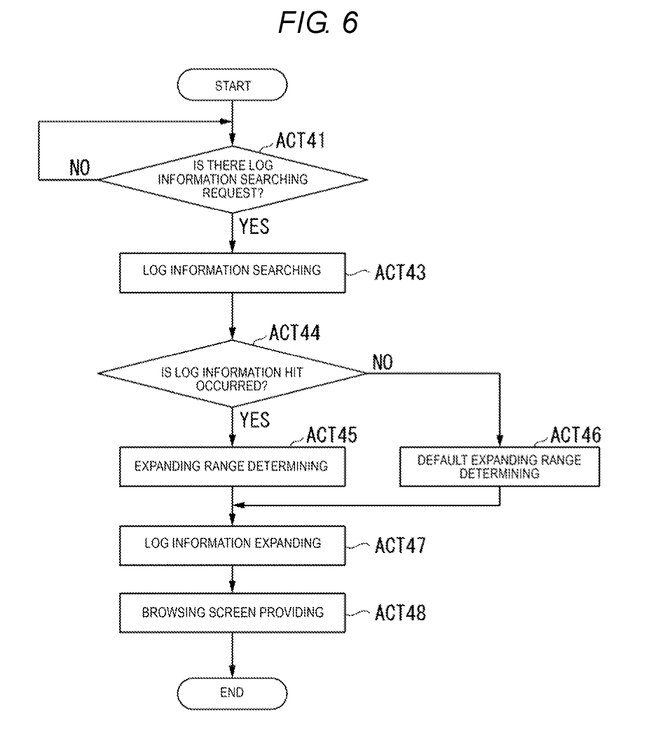

FIG. 6 is a flow chart illustrating an example of the log information expanding operation of the log information providing device 1. FIG. 5 illustrates a case where the log information expansion is triggered by the notification of the event information. On the other hand, FIG. 6 illustrates a case where the log information is expanded when there is a searching request of the log information from the service terminal 3. Therefore, for example, the log information providing device 1 can reduce the expansion time taken when browsing the log information even at arbitrary timing when the image forming apparatus 2 does not fail.

In FIG. 6, the log information providing device 1 determines whether the log information searching request is received (ACT 41). The log information searching request is received at an arbitrary timing from the service terminal 3. When it is determined that the log information searching request is not received (ACT 41: NO), the log information providing device 1 stands by the acquisition of the log information searching request by repeating the process of ACT 41.

On the other hand, when it is determined that the log information searching request is received (ACT 41: YES), the log information providing device 1 searches the stored log information based on the received log information searching request (ACT 43).

Since the processes of ACT 44 to ACT 48 after executing the process of ACT 43 are the same as the processes of ACT 34 to ACT 38 in FIG. 5, the description will not be described.

By the above processes, when there is the searching request of the log information from the service terminal 3, the log information predicted to be of interest becomes expanded. In the searching request of the log information, the condition for searching the log information is often narrow compared to the error notification. In addition, it is assumed that a certain time is free from start of the expanding of the log information in the process of ACT 37 illustrated in FIG. 5 until the service person actually starts the browsing of the log information. On the other hand, in FIG. 5, it is assumed that the service person waits for the expansion in the process of ACT 47. Accordingly, in the determination of the expansion range illustrated in FIG. 5 and the determination of the expansion range illustrated in FIG. 6, the determined expansion ranges are optimized, thereby further realizing maintenance efficiency of the image forming apparatus 2 by the service person.

FIG. 7 is a flow chart illustrating an example of a log information browsing operation of the log information providing device of the embodiment.

In FIG. 7, the log information providing device 1 determines whether the log information browsing request is received from the service terminal 3 (ACT 51). When it is determined that the log information browsing request is received (ACT 51: YES), the log information providing device 1 searches the log information based on the log information browsing request (ACT 52).

After executing the process of ACT 52, the log information providing device 1 determines whether the searched log information is in the expansion range in which the log information was previously expanded (ACT 53). When it is determined that the searched log information is not in the previous expansion range (ACT 53: NO), the log information providing device 1 enlarges the expansion range in addition to the expansion range which is required to browse (ACT 54).

After the process of ACT 54, the log information providing device 1 uses machine learning so that the expansion range is enlarged (ACT 55). A learning model of the machine learning to be used in the present embodiment is arbitrary. As the learning model, for example, a support vector machine (SVM) can be used. In the SVM, the expansion range which is determined based on the searching condition and whether the enlarging of the expansion range is required are learned as teacher data. A classifier of the SVM classifies the class determined based on the learning result into two classes including a class that is required to enlarge the expansion range and a class which is not required to enlarge the expansion range.

After executing the process of ACT 55 or when it is determined that the searched log information is the expansion range (ACT 53: NO), the log information providing device 1 provides the log information with respect to the service terminal 3 which is a requester that is the origin of the log information browsing request (ACT 56). After executing the process of ACT 56, the log information providing device 1 executes the process of ACT 51 again.

On the other hand, when it is determined that there is no log information browsing request in the process of ACT 51 (ACT 51: NO), the log information providing device 1 determines whether the browsing process is ended (ACT 57). For example, when the log information browsing request cannot be received fora predetermined time period, the log information providing device 1 can determine that the browsing process is ended. The log information providing device 1 may determines that the browsing process is ended by receiving an explicit ending instruction from the service terminal 3.

There a case where it is determined that the browsing process is not ended (ACT 57: NO), in which case the log information providing device 1 executes the process of ACT 51 again.

On the other hand, there is a case where it is determined that the browsing process is ended (ACT 57: YES), in which case the log information providing device 1 determines whether the non-browsing log information is included in the log information which is expanded within the expansion range (ACT 58).

In the present embodiment, since the log information to be browsed is used for maintenance of the image forming apparatus 2, for example, the predetermined continued log information items are often browsed until the predetermined time in the past. That is, in the process of ACT 58, when the non-browsing log information is included, the predetermined log information items are often continued in also the non-browsing log information. For example, when the expansion range is the past 7 days, and when the log information is browsed with respect to only the past 3 days, the log information in the past 4-7 days become the non-browsing log information.

When it is determined that the non-browsing log information is included in the log information expanded within the expansion range (ACT 58: YES), the log information providing device 1 uses machine learning to determine an expansion range contraction (ACT 59). Also in the machine learning of the expansion range contraction, the learning model such as SVM can be used in the same manner as that of the machine learning of the expansion range enlargement direction in the process of ACT 55.

After executing the process of ACT 59 or when it is determined that the non-browsing log information is not included (ACT 58: NO), the log information providing device 1 corrects the setting of the expansion range based on the learning result of the machine learning (ACT 60). The setting of the expansion range can be corrected for each of the searching conditions. In the machine learning, with respect to similar searching conditions, the similar searching condition may be corrected in the combination manner in accordance to the contribution rate of the searching condition such as the searching keyword.

In the present embodiment, an optimum value of the expansion range is the expansion range which is minimum required. By optimizing the expansion range, the time required for expanding can be reduced. Since a loss of time when the expansion range is too narrow and the re-expanding of the log information is required is directly applied on the service person, it is preferable that the loss coefficient in the machine learning is greater when the log information which is not browsed due to the excessively broad the expansion range is used.

According to at least one of the embodiments described above, the log information providing method receives the log information of the image forming apparatus, in a log information receiving step. In a compressing step, the received log information is compressed. In a storing step, the compressed log information is stored. In an event information receiving step, event information is received. In a searching step, the stored log information is searched based on the received event information. In a determining step, an expansion range of the log information is determined based on the searched log information. In an expanding step, the log information is expanded in the determined expansion range. In a browsing request receiving step, a browsing request of the stored log information is received. In a learning step, an association between the log information browsed based on the browsing request and the determined expansion range is learned. In a correcting step, the range in the determining step is corrected based on the learned association.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A method of providing access to stored and compressed log information of one or more image forming apparatuses, the method comprising the steps of:
in response to receiving a request for log information, searching the stored log information based on the received request;
determining an expansion range of the log information based on the searched log information and predetermined setting information;
expanding the log information corresponding to the determined expansion range;
receiving a browsing request to browse a portion of the stored log information;
transmitting the portion of the stored log information;
machine learning an association between the log information browsed based on the browsing request and the determined expansion range;
determining a correction to the determined expansion range based on the learned association; and
storing the correction as the predetermined setting information.

2. The method according to claim 1, wherein, when the portion of the browsed log information included in the browsing request is not within the determined expansion range, the machine learning includes determining that the determined expansion range will be enlarged for future similar event information.

3. The method according to claim 1, wherein, when the expanded log information includes log information that is not within the portion of the browsed log information included in the browsing request, the machine learning includes determining that the determined expansion range will be contracted for future similar event information.

4. The method according to claim 1, wherein the received request is transmitted from the image processing apparatus in response to a failure event in the image processing apparatus.

5. The method according to claim 4, wherein the stored log information is searched based at least on the failure event.

6. The method according to claim 1, wherein the received request is a search request transmitted from a service terminal.

7. The method according to claim 6, wherein the stored log information is searched based on at least one search criteria included in the search request.

8. A server for providing access to stored and compressed log information of one or more image forming apparatuses, the server including a processor that is programmed to carry out the steps of:
determining an expansion range of the log information based on the searched log information and predetermined setting information;
expanding the log information corresponding to the determined expansion range;
receiving a browsing request to browse a portion of the stored log information;
transmitting the portion of the stored log information;
machine learning an association between the log information browsed based on the browsing request and the determined expansion range;
determining a correction to the determined expansion range based on the learned association; and
storing the correction as the predetermined setting information.

9. The server according to claim 8, wherein, when the portion of the browsed log information included in the browsing request is not within the determined expansion range, the machine learning includes determining that the determined expansion range will be enlarged for future similar event information.

10. The server according to claim 8, wherein, when the expanded log information includes log information that is not within the portion of the browsed log information included in the browsing request, the machine learning includes determining that the determined expansion range will be contracted for future similar event information.

11. The server according to claim 8, wherein the received request is transmitted from the image processing apparatus in response to a failure event in the image processing apparatus.

12. The server according to claim 11, wherein the stored log information is searched based at least on the failure event.

13. The server according to claim 8, wherein the received request is a search request transmitted from a service terminal.

14. The server according to claim 13, wherein the stored log information is searched based on at least one search criteria included in the search request.

15. A non-transitory computer readable medium containing instructions causing a computer to perform a method of providing access to stored and compressed log information of one or more image forming apparatuses, the method comprising the steps of:
in response to receiving a request for log information, searching the stored log information based on the received request;
determining an expansion range of the log information based on the searched log information and predetermined setting information;
expanding the log information corresponding to the determined expansion range;
receiving a browsing request to browse a portion of the stored log information;
transmitting the portion of the stored log information;
machine learning an association between the log information browsed based on the browsing request and the determined expansion range;
determining a correction to the determined expansion range based on the learned association; and
storing the correction as the predetermined setting information.

16. The non-transitory computer readable medium according to claim 15, wherein, when the portion of the browsed log information included in the browsing request is not within the determined expansion range, the machine learning includes determining that the determined expansion range will be enlarged for future similar event information.

17. The non-transitory computer readable medium according to claim 15, wherein, when the expanded log information includes log information that is not within the portion of the browsed log information included in the browsing request, the machine learning includes determining that the determined expansion range will be contracted for future similar event information.

18. The non-transitory computer readable medium according to claim 15, wherein the received request is transmitted from the image processing apparatus in response to a failure event in the image processing apparatus.

19. The non-transitory computer readable medium according to claim 18, wherein the stored log information is searched based at least on the failure event.

20. The non-transitory computer readable medium according to claim 15, wherein:
the received request is a search request transmitted from a service terminal, and
the stored log information is searched based on at least one search criteria included in the search request.
